(19) United States
(12) Patent Application Publication
(10) Pub. No.: US 2004/0165643 A1
(43) Pub. Date: Aug. 26, 2004

(54) Device for collimating a high-brightness laser diode array

(75) Inventor: Yves Lutz, Hesingue (FR)

Correspondence Address: OLIFF & BERRIDGE, PLC, P.O. BOX 19928, ALEXANDRIA, VA, 22320, US

(73) Assignee: INSTITUT FRANCO-ALLEMAND DE RECHERCHES DE SAINT- LOUIS, SAINT-LOUIS CEDEX (FR)

(21) Appl. No.: 10/680,187

(22) Filed: Oct. 8, 2003

(30) Foreign Application Priority Data
Oct. 10, 2002 (FR) 02 12572

(51) Int. Cl. H01S 3/08

(52) U.S. Cl. 372/108

(57) ABSTRACT

The present invention relates in particular to the field of devices using stimulated emission, specifically to a device for collimating high-brightness laser diode array (1) characterized in that by comprising at least one optical fiber (2) whose first end (7) is thermoformed and is located in the vicinity of an opposite the high-brightness array (1), the numerical aperture of said optical fiber end being greater than the numerical aperture of the source.

### BACKGROUND OF THE INVENTION

1. Field of Invention

The present invention relates in particular to devices using stimulated emission and relates in particular to a device for collimating a high-brightness laser diode stack or array.

2. Description of Related Art

For recording nighttime images in the total absence of light of a scene containing rapidly moving objects at great distances, it is essential to combine a specific lighting source with the viewing device (optics+camera). The particular characteristics of this source are: directivity, high peak power, and wavelength centered on the maximum sensitivity of the detector used. The laser has these properties, and among the various types of laser sources, the semi-conductor laser or diode laser appears most suitable due to its excellent properties in terms of optical/electrical efficiency, performance, compactness, and cost. The fact that this type of source requires no alignment or adjustment of the cavity makes it particularly suitable for utilization in harsh environments (vibrations and impacts). So that sufficient illumination power is available, components with multiple emitters disposed in a 2D array on the emitting surface are used, where each emitter represents a laser. The total power of the component is then achieved by adding the power of each emitter. In the case of “classical” arrays, up to 200 emitters per component are found for a total emitting surface area of 10×10 mm. Each emitter of this array emits a laser beam with a divergence of approximately 10° along an axis parallel to the junction and a divergence of approximately 40° along an axis perpendicular to the junction. To obtain a usable laser beam, i.e. one with less divergence that is symmetrical along the two axes, it is necessary to collimate these beams. The techniques used in the case of classical arrays are numerous. If a higher illumination power is suitable, either the size of the emitter array may be increased or the density of the emitters on the emitting surface may be increased.

The first approach has one major drawback which is the excessive increase in the size of the total emitting surface. The component thus loses its compactness and rigidity; moreover, the brightness of the source is reduced, which has a direct impact on the dimensions of the beam-shaping optics.

A second method is to increase the density of the emitters on the array. This increases both the brightness of the source and the compactness of the component. Such components have recently appeared on the market under the name of high-brightness matrix or stack. Such components have up to a thousand emitters or lasers on a surface measuring 10×1.5 mm. This increased density has two drawbacks, however, namely that cooling is more difficult and collimation is more difficult. Cooling has a direct effect on the average power or on the repetition rate, which is lower than in the case of classical arrays. A high-brightness array, however, enables high peak powers to be used at a repetition rate higher than the video rate (25 Hz). A higher emitter density has an effect on beam collimation. The distance between the emitters of a classical array enables each emitter to be associated with its own microlens or microfiber. In the case of high-brightness arrays, the emitter density makes these collimation techniques unusable.

U.S. Pat. No. 5,825,803 describes the use of lenses made of gradient index fibers, the lengthwise axis of the fiber being disposed perpendicularly to the light source. In this way, one emitter row of the array is collimated. A second collimation device must be provided to handle the array columns.

### SUMMARY OF THE INVENTION

Manufacturing such a lens is complex and the slightest quality or alignment defect of the lens causes a collimation defect.

The goal of the invention is to provide a high-brightness array collimation device enabling both axes to be treated simultaneously, that is simple both to manufacture and to implement, and which is highly compact.

The solution is a device for collimating a high-brightness array having a plurality of point sources and at least two optical fibers, characterized in that the number of optical fibers is less than the number of sources and in that the first end of these fibers is located in the vicinity of and opposite said high-brightness array sources, the numerical aperture of said end of these optical fibers being greater than the numerical aperture of said sources.

“Vicinity” is understood as a distance of 0.1 to 0.5 mm.

The numerical aperture of the source is defined as the sine of half the angle of its most divergent emission while the numerical aperture of the fiber is defined as the sine of half the angle θ of acceptance by the fiber, namely of the maximum angle at which the fiber can pick up a ray of light.

According to one feature enabling the injection efficiency of the radiation emitted by the high-brightness array to be optimized, the fiber has a diameter that is greater than the higher of the emitting surface.

According to one feature enabling the injection efficiency to be optimized and its size to be minimized, the device has at least one collimating lens disposed at the second end of the fiber.

### BRIEF DESCRIPTION OF THE DRAWINGS

Other advantages and characteristics will emerge from the description of a particular embodiment of the invention with reference to the attached figures:

FIG. 1 is a diagram of an emitting surface comprised of a high-brightness array;

FIG. 2 shows schematically the injection of light in the optical fiber;

FIGS. 3a and 3b illustrate the interface between said matrix and the collimation means according to one particular embodiment of the invention;

FIG. 4 shows all the collimation means according to one particular embodiment;

FIG. 5 shows the profile of the laser beam exiting an optical fiber used to collimate the radiation generated by the high-brightness array; and

FIG. 6 shows the profile of the laser beam obtained as it leaves the collimation means illustrated in FIG. 4.

### DETAILED DESCRIPTION OF PREFERRED EMBODIMENTS

The component to be collimated is shown schematically in FIG. 1. It is an emitting surface composed of 900 laser emitter sources such as laser diodes. The dimensions of the total emitting surface are 1.5×9.6 mm. This emitting surface may be considered as a point source with a divergence of 10° along an axis parallel to the junction and generally called “slow axis” and a divergence of approximately 40° along an axis perpendicular to the junction, said axis generally being called “fast axis.”

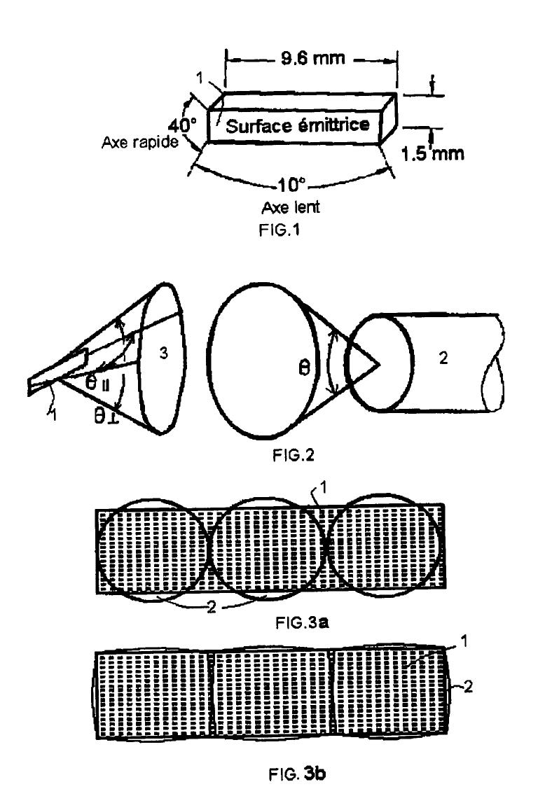

To achieve symmetrical laser radiation along the two axes, with controlled divergence, it is accordingly necessary to collimate the radiation coming from this emitting surface 1. As shown in FIG. 2, this radiation is collimated by at least one optical fiber one of whose ends is disposed opposite and in the vicinity of the emitting surface 1.

Considering the emitting surface 1 as a point source, the multimode optical fiber captures the overall envelope of the beam 3.

The optical fiber 2 is positioned opposite the emitting surface and at a non-critical distance “e” of approximately 0.3 mm, the fiber also having the following characteristics:

an acceptance angle θ greater than the highest divergence of the radiating elements of which the high-brightness array is composed;

a diameter greater than the height of the emitting surface.

In addition, to minimize the lateral dimension, the fiber envelope must be as thin as possible, for example approximately 10 μm.

Also, it is preferable to use a plastic fiber, for example a thermoformable fiber. As shown in FIGS. 3a and 3b, this characteristic enables the shape of the fibers 2 to be adapted to the geometry of the emitting surface 1, thus improving the injection efficiency of the light in the fiber. Since the fibers originally have a circular cross section, they are shaped by thermoforming so that, when they are juxtaposed, they have substantially the same shape as the emitting surface 2.

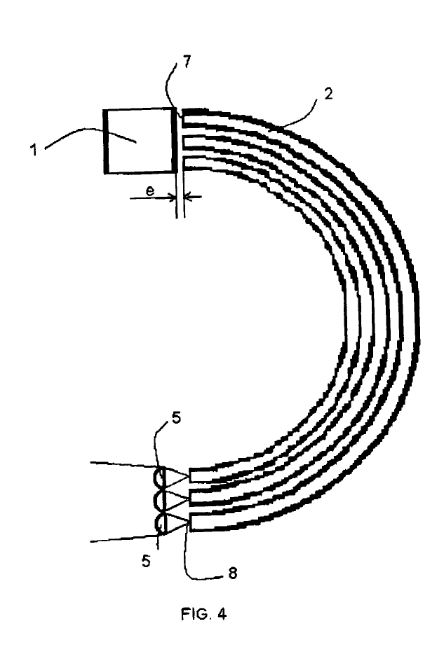

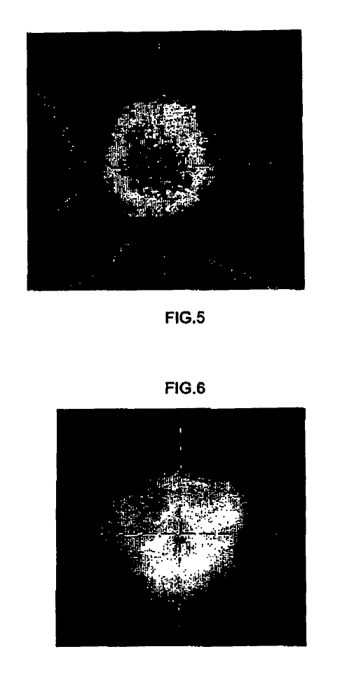

As shown in FIG. 4, each fiber 2 has two ends, 7 and 8, the first end 7 being disposed opposite the high-brightness array while the second 8 is located opposite one collimating lens 5. Each optical fiber 2 is long enough to allow transmission of the beam to a position, which may be offset, where the collimating lenses 5 are placed. These lenses allow a directive, homogeneous beam 6 to be obtained.

In this example, for an emitting surface dimension of 1.5×9.6 mm, three PMMA fibers with 3 mm in diameter and with a numerical aperture of 0.5 are used. The fiber envelope is made of fluoropolymer with 30 μm of thickness to improve the injection efficiency in the fiber. The end of the fiber is adapted by thermoforming to the diode emitting surface.

Without optimization of the material of the fiber body, which has non-negligible absorption at 800 nm, which is the emission wavelength of the diode, and without antireflection coatings on the fiber, injection efficiencies of 75% are obtained with the formed fiber ends, versus 65% without thermoforming. The length of the fiber is 30 cm. At the other end of the fiber, the beam is collected with a converging lens 5 to obtain the desired lighting angle.

FIG. 5 shows the profile of the laser beam at the output of the optical fiber, the divergence of the beam being given by the numerical aperture of the fiber; the beam may be seen to be symmetrical and circular with the maximum intensity at the center.

FIG. 6 shows the profile of the beam downstream of the collimation lenses 5, i.e. once it has been homogenized and collimated by an optical fiber and homogenized by said lens. The beam may be seen to have good uniformity, which is of particular value in the context of scenes illumination.

A device according to the invention has the advantage of using only a few lenses, generally one per optical fiber, which considerably limits the size and considerably reduces the number of parts necessary for its operation.

1. Device for obtaining a high-power homogenous directive collimated beam particularly for lighting scenes, said device having a high-brightness matrix including a plurality of point sources and at least two optical fibers, characterized in that the number of optical fibers is less than the number of sources and in that the first end of these fibers is located in the vicinity of and opposite said high-brightness array sources, the numerical aperture of said end of these optical fibers being greater than the numerical aperture of said sources.

2. Device according to claim 1, characterized in that the fiber is made of plastic.

3. Device according to claim 2, characterized in that the fiber is made of thermoformable plastic.

4. Device according to claim 1, characterized in that the fiber has a diameter that is greater than the height of the emitting surface.

5. Device according to claim 1, characterized in that the fiber has a thin emitter, namely an emitter whose thickness is less than a few tens of microns.

6. Device according to claim 1, characterized in that it has at least one collimating lens disposed at the second end of the fiber.

7. Device according to claim 1, characterized in that the point sources are comprised of laser sources.

8. Device according to claim 7, characterized in that the point sources are comprised of laser diodes.

9. Collimation method for a high-brightness array having a plurality of sources, characterized in that it consists of disposing the first end of an optical fiber opposite the emissive face of said array and in the vicinity of the latter, the numerical aperture of said end of said optical fiber being greater than the numerical aperture of said sources.

10. Method according to claim 9, characterized in that it includes a forming step to adapt the shape of said first fiber end to the geometry of said array.
